(19) United States
(12) Patent Application Publication
(10) Pub. No.: US 2026/0125293 A1
(43) Pub. Date: May 7, 2026

(54) WATERWAY SYSTEM WITH RO FILTER ELEMENT

(71) Applicant: Hua Cui, Henan Province (CN)

(72) Inventor: Hua Cui, Henan Province (CN)

(21) Appl. No.: 19/076,929

(22) Filed: Mar. 11, 2025

(30) Foreign Application Priority Data
Nov. 1, 2024 (CN) 202411546974.X

(51) Int. Cl. C02F 1/44

(52) U.S. Cl. CPC C02F 1/441; C02F 2201/005; C02F 2307/14

(57) ABSTRACT

Disclosed is a waterway system with an RO filter element, including an outer cylinder, an RO membrane, an RO membrane central tube, and an inner RO membrane central tube; a water inlet, a purified water outlet and a wastewater outlet are arranged at a lower end of the outer cylinder, and a valve assembly is installed in each of the water inlet, the purified water outlet and the wastewater outlet respectively; a waterway passage I is formed inside the inner RO membrane central tube, and a waterway passage II is formed; and a waterway passage III is formed between the inner RO membrane central tube and the RO membrane central tube, and the waterway passage III is communicated with the waterway passage II. The RO membrane has a double-layer central tube waterway structure that does not restrict a waterway direction of the water inlet.

### TECHNICAL FIELD

The present disclosure relates to the technical field of RO filter elements, and in particular to a waterway system with an RO filter element.

### BACKGROUND

The patent with the publication No. CN218507603U discloses an RO filter element. The RO filter element includes a filter element cylinder, an RO membrane, water stop valves, a bottom cover, a U-shaped decorative cover, and a handle, where the RO membrane is inserted into the filter element cylinder, a wastewater outlet, a purified water outlet and a water inlet are sequentially arranged at one end of the filter element cylinder, and the water stop valves are arranged in the wastewater outlet and the purified water outlet. The water stop valve includes a valve element, a valve seat, a return spring, a valve element sealing ring and a valve seat sealing ring, where the return spring is sleeved at an outer periphery of the valve element, one end of the valve element and one end of the return spring need to be inserted into the valve seat, the valve element sealing ring is sleeved at an end portion of the valve element, the valve seat sealing ring is sleeved at an outer periphery of the valve seat, a drainage pipe of the RO membrane is connected to the purified water outlet, and the wastewater outlet and the water inlet are respectively connected to an internal cavity of the filter element cylinder in a penetrating manner. The defects of this RO filter element lie in that the RO membrane has a single-layer central tube waterway structure that restricts a waterway direction of the water inlet, and a large amount of raw water and mixed wastewater accumulate inside the membrane after entry from an outer wall of the RO membrane, thereby leading to secondary neutralization of a first cup of water, increased total dissolved solids (TDS), or foul odors during use, and failing to ensure the stability of water quality.

Therefore, there is room for improvement in the prior art.

### SUMMARY

To solve the problems in the prior art, the present disclosure provides a waterway system with an RO filter element. An RO membrane has a double-layer central tube waterway structure that does not restrict a waterway direction of a water inlet, where water can enter through an inner RO membrane central tube or through a wastewater outlet, and a volume of a water inlet passage is reduced, such that a large amount of purified water remains in the waterway system with an RO filter element, thus preventing an increase in total dissolved solids (TDS) and ensuring stability of water quality.

In order to realize the above objective, the technical solution of the present disclosure is as follows:
a waterway system with an RO filter element, including an outer cylinder, an RO membrane, an RO membrane central tube, and an inner RO membrane central tube; the inner RO membrane central tube is installed inside the RO membrane central tube, the RO membrane central tube is installed inside the RO membrane, and the RO membrane is installed inside the outer cylinder; a water inlet, a purified water outlet and a wastewater outlet are arranged at a lower end of the outer cylinder, and a valve assembly is installed in each of the water inlet, the purified water outlet and the wastewater outlet respectively; a waterway passage I is formed inside the inner RO membrane central tube, and the water inlet is communicated with the waterway passage I; a waterway passage II is formed between an outer wall of the RO membrane and an inner wall of the outer cylinder, and the purified water outlet is communicated with the waterway passage II; and a waterway passage III is formed between an outer wall of the inner RO membrane central tube and an inner wall of the RO membrane central tube, and the waterway passage III is communicated with the waterway passage II.

According to the above solution, an opening for installation of the inner RO membrane central tube is formed at a lower end of the RO membrane central tube, a baffle is formed at an upper end of the RO membrane central tube, the baffle is provided with a central hole that cooperates with the waterway passage I, a plurality of water passing holes II are formed around an outer periphery of the central hole, and a plurality of water passing holes I are formed on an outer wall of the RO membrane central tube.

According to the above solution, a lower end cover is fixed at a lower end of the RO membrane, an upper end cover is fixed at an upper end of the RO membrane, and the upper end cover is provided with a plurality of through holes that are arranged to cooperate with the water passing holes II.

According to the above solution, an opening for the installation of the RO membrane is formed at an upper end of the outer cylinder, an outer end cover is detachably installed on the opening, and a limiting assembly is arranged between the outer end cover and the upper end cover.

According to the above solution, the limiting assembly includes a limiting groove located at a center of an inner wall of the outer end cover and a limiting block located at a center of an outer wall of the upper end cover, where the limiting block corresponds to the limiting groove.

According to the above solution, a decorative handle is fixed on an outer side of the outer end cover, and a LOGO identifier is fixed on an outer side of the decorative handle.

According to the above solution, a silica gel ring V is sleeved on an outer wall of a lower end of the inner RO membrane central tube, and a silica gel ring IV is sleeved on an outer wall of an upper end of the inner RO membrane central tube.

According to the above solution, a silica gel ring III is sleeved around outside of each of the water passing holes II.

According to the above solution, a silica gel ring VI is sleeved on an outer wall of the lower end cover.

According to the above solution, the valve assembly includes an ultrasonic cover, a water cutoff accessory, and a water cutoff piece, where a silica gel ring II is sleeved on an outer wall of an upper end of the water cutoff piece, a lower end of the water cutoff piece is located inside the water cutoff accessory, a spring is arranged inside the water cutoff accessory, the spring is sleeved on the lower end of the water cutoff piece, both ends of the spring abut against the water cutoff piece and the water cutoff accessory, respectively, the ultrasonic cover is fixed on the outer cylinder, and a silica gel ring I is arranged between the ultrasonic cover and the water cutoff accessory.

The present disclosure has the following beneficial effects:
Due to such arrangement, the RO membrane has a double-layer central tube waterway structure that does not restrict a waterway direction of the water inlet, where water can enter through the inner RO membrane central tube or through the wastewater outlet, and a volume of a water inlet passage is reduced, such that a large amount of purified water remains in the waterway system with an RO filter element, thus preventing an increase in TDS and ensuring stability of water quality.

### BRIEF DESCRIPTION OF THE DRAWINGS

FIG. 1 is an exploded view of an overall structure of the present disclosure.

FIG. 2 is a sectional view of an overall structure of the present disclosure.

FIG. 3 is an enlarged view of a part A in FIG. 2.

FIG. 4 is an enlarged view of a part B in FIG. 2.

FIG. 5 is a schematic diagram of a baffle at an end portion of an RO membrane central tube.

FIG. 6 is a directional schematic diagram of a waterway I of the present disclosure.

FIG. 7 a directional schematic diagram of a waterway II of the present disclosure.

FIG. 8 is a schematic diagram of assembly of an inner RO membrane central tube and an RO membrane central tube of the present disclosure.

In the figures:
1. ultrasonic cover; 2. silica gel ring I; 3. spring; 4. water cutoff accessory; 5. water cutoff piece; 6. silica gel ring II; 7. outer cylinder; 8. RO membrane; 9. RO membrane central tube; 91. water passing hole I; 92. water passing hole II; 93. baffle; 94. central hole; 10. silica gel ring III; 11. inner RO membrane central tube; 12. silica gel ring IV; 13. silica gel ring V; 14. upper end cover; 141. through hole; 142. limiting block; 15. lower end cover; 16. outer end cover; 161. limiting groove; 17. decorative handle; 18. LOGO identifier; 19. silica gel ring VI; 21. waterway passage I; 22. waterway passage II; 23. waterway passage III; 31. water inlet; 32. purified water outlet; and 33. wastewater outlet.

### DETAILED DESCRIPTIONS OF THE EMBODIMENTS

A technical solution of the present disclosure will be described below with reference to accompanying drawings and examples.

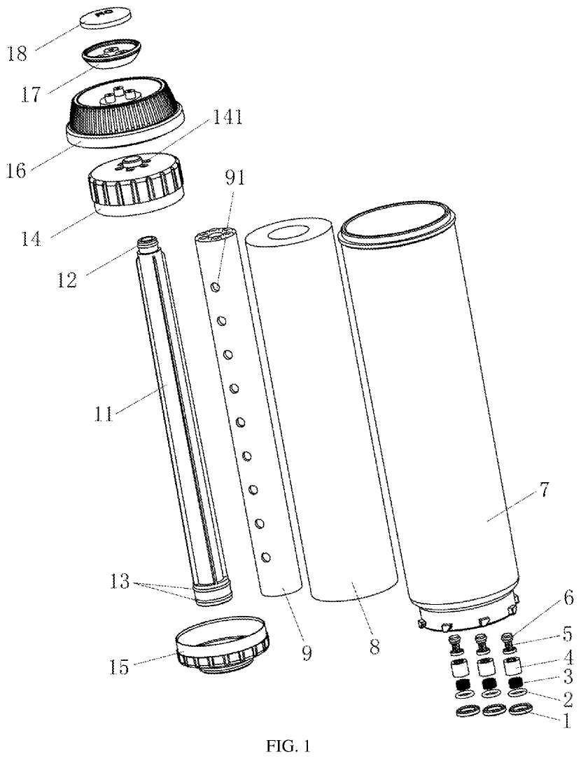

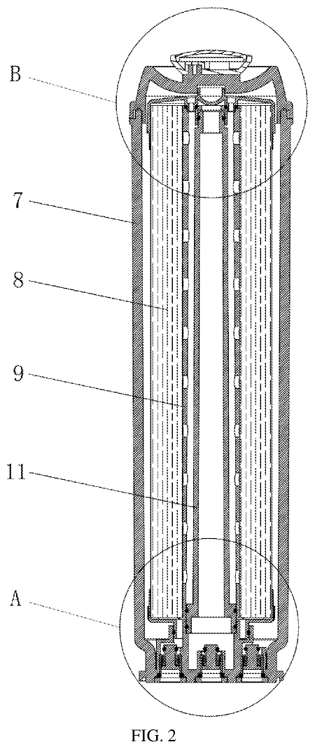

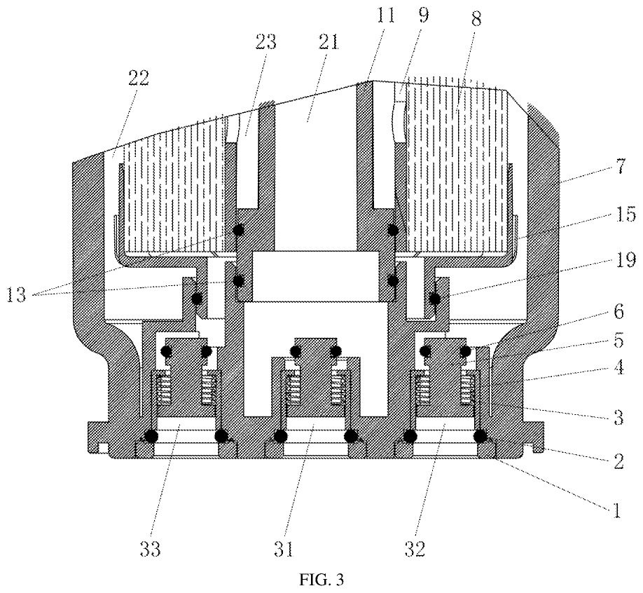

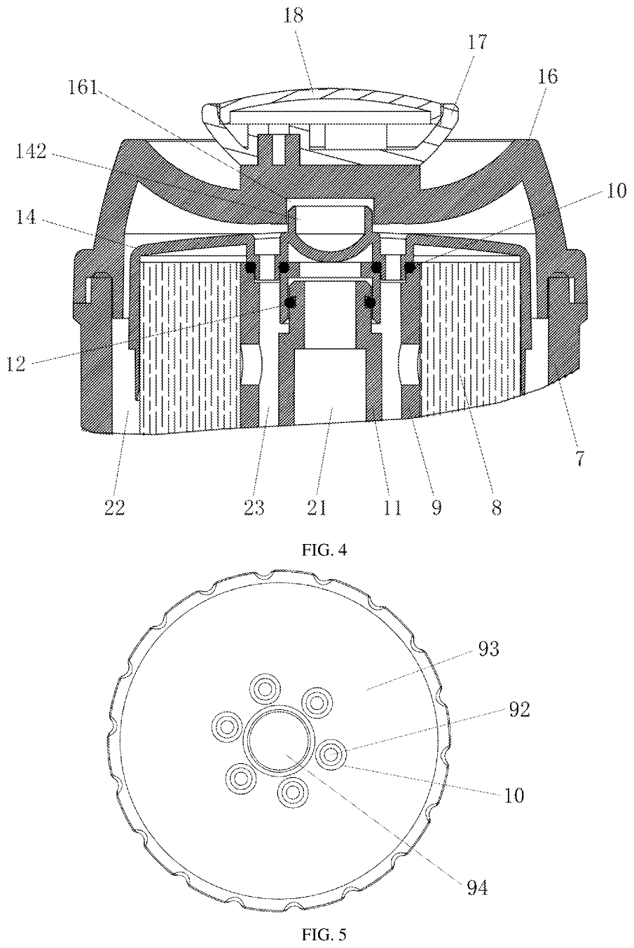

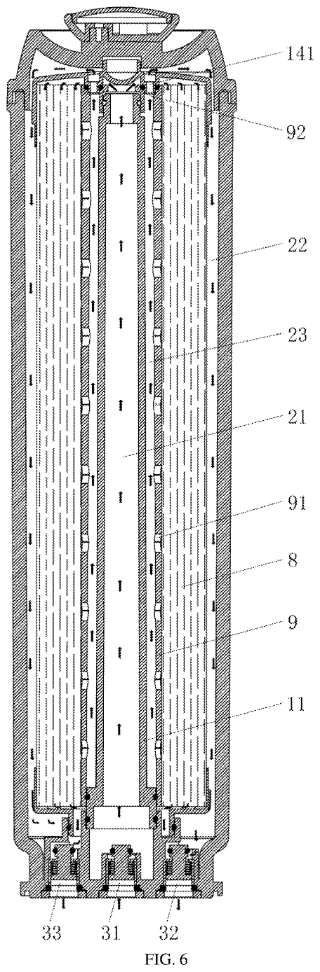

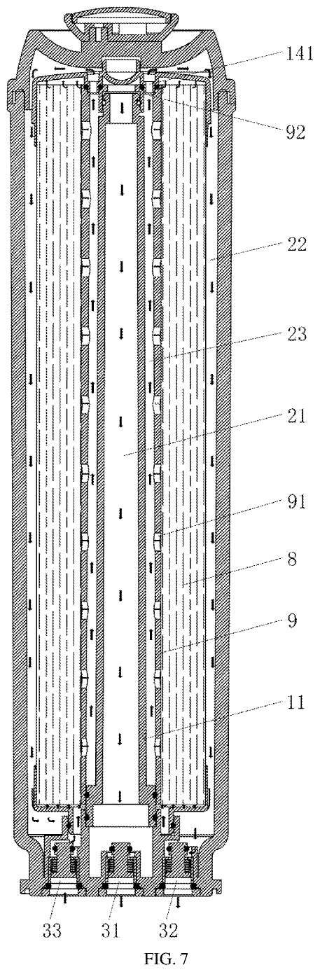

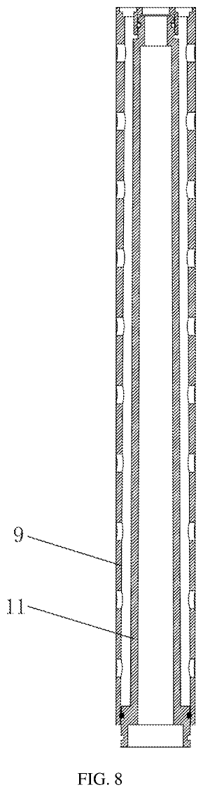

As illustrated in FIGS. 1-8, a waterway system with an RO filter element according to the present disclosure includes an outer cylinder 7, an RO membrane 8, an RO membrane central tube 9, and an inner RO membrane central tube 11; the inner RO membrane central tube 11 is installed inside the RO membrane central tube 9, the RO membrane central tube 9 is installed inside the RO membrane 8, and the RO membrane 8 is installed inside the outer cylinder 7; a water inlet 31, a purified water outlet 32 and a wastewater outlet 33 are arranged at a lower end of the outer cylinder 7, and a valve assembly is installed in each of the water inlet 31, the purified water outlet 32 and the wastewater outlet 33 respectively; a waterway passage I 21 is formed inside the inner RO membrane central tube 11, and the water inlet 31 is communicated with the waterway passage I 21; a waterway passage II 22 is formed between an outer wall of the RO membrane 8 and an inner wall of the outer cylinder 7, and the purified water outlet 32 is communicated with the waterway passage II 22; and a waterway passage III 23 is formed between an outer wall of the inner RO membrane central tube 11 and an inner wall of the RO membrane central tube 9, and the waterway passage III 23 is communicated with the waterway passage II 22. Due to such arrangement, the RO membrane 8 has a double-layer central tube waterway structure that does not restrict a waterway direction of the water inlet, where water can enter through the inner RO membrane central tube or through the wastewater outlet, and a volume of a water inlet passage is reduced, such that a large amount of purified water remains in the waterway system with an RO filter element, thus preventing an increase in total dissolved solids (TDS) and ensuring stability of water quality.

More specifically, according to forward and reverse osmosis characteristics of the RO membrane 8, two waterways are optional:
waterway I: water enters the waterway passage I 21 through the water inlet 31, enters the waterway passage III 23 through the RO membrane 8, and then returns to the waterway passage II 22 through the waterway passage III 23, and after such circulation, purified water is discharged from the purified water outlet 32 and wastewater is discharged from the wastewater outlet 33;
waterway II: water enters the waterway passage III 23 through the wastewater outlet 33 and the RO membrane 8 sequentially, and then returns to the waterway passage II 22 through the waterway passage III 23, and after such circulation, purified water is discharged from the purified water outlet 32, and wastewater is discharged from the water inlet 31 through the waterway passage I 21; and
in the present disclosure, by reducing the volume of a water inlet passage, a volume of purified water in the filter element is much larger than that of inlet water, and after the waterway system stops working, positive osmosis of the RO membrane 8 will not cause an increase in TDS in a short period of time.

Further, an opening for installation of the inner RO membrane central tube 11 is formed at a lower end of the RO membrane central tube 9, a baffle 93 is formed at an upper end of the RO membrane central tube 9, the baffle 93 is provided with a central hole 94 that cooperates with the waterway passage I 21, a plurality of water passing holes II 92 are formed around an outer periphery of the central hole 94, and a plurality of water passing holes I 91 are formed on an outer wall of the RO membrane central tube 9. Due to such arrangement, the inner RO membrane central tube 11 is assembled in the RO membrane central tube 9 through the opening, and an outlet of the inner RO membrane central tube 11 (or an outlet of the waterway passage I 21) cooperates with the central hole 94, which facilitates flow of water through the waterway passage I 21 into the waterway passage II 22, where water in the waterway passage II 22, through the RO membrane 8 and the plurality of water passing holes I 91, enters the waterway passage III 23, and water in the waterway passage III 23, through the water passing holes II 92, returns to the waterway passage II 22. Water circulation ensures that positive osmosis of the RO membrane 8 will not cause an increase in TDS in a short period of time, thereby ensuring the stability of water quality.

Further, a lower end cover 15 is fixed at a lower end of the RO membrane 8, an upper end cover 14 is fixed at an upper end of the RO membrane 8, and the upper end cover 14 is provided with a plurality of through holes 141 that are arranged to cooperate with the water passing holes II 92. Due to such arrangement, water in the waterway passage III 23, through the water passing holes II 92 and then the through holes 141, returns to the waterway passage II 22.

Further, an opening for the installation of the RO membrane 8 is formed at an upper end of the outer cylinder 7, an outer end cover 16 is detachably installed on the opening, and a limiting assembly is arranged between the outer end cover 16 and the upper end cover 14.

Further, the limiting assembly includes a limiting groove 161 located at a center of an inner wall of the outer end cover 16 and a limiting block 142 located at a center of an outer wall of the upper end cover 14, where the limiting block 142 corresponds to the limiting groove 161. Due to such arrangement, after assembly, the RO membrane 8, the RO membrane central tube 9, and the inner RO membrane central tube 11 do not tilt relative to the outer cylinder 7, such that waterway performance will not be affected.

Further, a decorative handle 17 is fixed on an outer side of the outer end cover 16, and a LOGO identifier 18 is fixed on an outer side of the decorative handle 17. Such arrangement facilitates movement of the RO filter element.

Further, a silica gel ring V 13 is sleeved on an outer wall of a lower end of the inner RO membrane central tube 11, and a silica gel ring IV 12 is sleeved on an outer wall of an upper end of the inner RO membrane central tube 11. Due to such arrangement, the lower end of the RO membrane central tube 9 and the lower end of the inner RO membrane central tube 11 can be sealed through the silica gel ring V 13, and the upper end of the RO membrane central tube 9 and the upper end of the inner RO membrane central tube 11 can be sealed through the silica gel ring IV 12, thereby preventing water leakage.

Further, a silica gel ring III 10 is sleeved around outside of each of the water passing holes II 92. Due to such arrangement, the upper end of the RO membrane central tube 9 and the upper end cover 14 can be sealed to prevent water leakage.

Further, a silica gel ring VI 19 is sleeved on an outer wall of the lower end cover 15. Due to such arrangement, the lower end cover 15 and the outer cylinder 7 can be sealed to prevent water leakage.

Further, the valve assembly includes an ultrasonic cover 1, a water cutoff accessory 4, and a water cutoff piece 5, where a silica gel ring II 6 is sleeved on an outer wall of an upper end of the water cutoff piece 5, a lower end of the water cutoff piece 5 is located inside the water cutoff accessory 4, a spring 3 is arranged inside the water cutoff accessory 4, the spring 3 is sleeved on the lower end of the water cutoff piece 5, both ends of the spring 3 abut against the water cutoff piece 5 and the water cutoff accessory 4, respectively, the ultrasonic cover 1 is fixed on the outer cylinder 7, and a silica gel ring I 2 is arranged between the ultrasonic cover 1 and the water cutoff accessory 4. Due to such arrangement, when the upper end of the water cutoff piece 5 rises and detaches from the water cutoff accessory 4, the spring 3 is compressed to open the waterway, and when the water cutoff piece 5 is not under pressure, resetting occurs under the action of a rebound force of the spring 3, to close the waterway.

The examples of the present disclosure are described above with reference to accompanying drawings. However, the present disclosure is not limited to the above specific embodiments, and the above specific embodiments are merely illustrative and not restrictive. Those skilled in the art, under inspiration of the present disclosure, can make numerous variations without departing from the spirit and scope of the present disclosure as defined in the claims. All these variations fall within the scope of protection of the present disclosure.

What is claimed is:

1. A waterway system with an RO filter element, comprising:
an outer cylinder, an RO membrane, an RO membrane central tube, and an inner RO membrane central tube;
the inner RO membrane central tube is installed inside the RO membrane central tube, the RO membrane central tube is installed inside the RO membrane, and the RO membrane is installed inside the outer cylinder;
a water inlet, a purified water outlet and a wastewater outlet are arranged at a lower end of the outer cylinder, and a valve assembly is installed in each of the water inlet, the purified water outlet and the wastewater outlet respectively;
a waterway passage I is formed inside the inner RO membrane central tube, and the water inlet is communicated with the waterway passage I;
a waterway passage II is formed between an outer wall of the RO membrane and an inner wall of the outer cylinder, and the purified water outlet is communicated with the waterway passage II; and
a waterway passage III is formed between an outer wall of the inner RO membrane central tube and an inner wall of the RO membrane central tube, and the waterway passage III is communicated with the waterway passage II.

2. The waterway system with an RO filter element according to claim 1, wherein an opening for installation of the inner RO membrane central tube is formed at a lower end of the RO membrane central tube, a baffle is formed at an upper end of the RO membrane central tube, the baffle is provided with a central hole that cooperates with the waterway passage I, a plurality of water passing holes II are formed around an outer periphery of the central hole, and a plurality of water passing holes I are formed on an outer wall of the RO membrane central tube.

3. The waterway system with an RO filter element according to claim 2, wherein a lower end cover is fixed at a lower end of the RO membrane, an upper end cover is fixed at an upper end of the RO membrane, and the upper end cover is provided with a plurality of through holes that are arranged to cooperate with the water passing holes II.

4. The waterway system with an RO filter element according to claim 3, wherein an opening for installation of the RO membrane is formed at an upper end of the outer cylinder, an outer end cover is detachably installed on the opening, and a limiting assembly is arranged between the outer end cover and the upper end cover.

5. The waterway system with an RO filter element according to claim 4, wherein the limiting assembly comprises a limiting groove located at a center of an inner wall of the outer end cover and a limiting block located at a center of an outer wall of the upper end cover, wherein the limiting block corresponds to the limiting groove.

6. The waterway system with an RO filter element according to claim 4, wherein a decorative handle is fixed on an outer side of the outer end cover, and a LOGO identifier is fixed on an outer side of the decorative handle.

7. The waterway system with an RO filter element according to claim 2, wherein a silica gel ring V is sleeved on an outer wall of a lower end of the inner RO membrane central tube, and a silica gel ring IV is sleeved on an outer wall of an upper end of the inner RO membrane central tube.

8. The waterway system with an RO filter element according to claim 2, wherein a silica gel ring III is sleeved around outside of each of the water passing holes II.

9. The waterway system with an RO filter element according to claim 3, wherein a silica gel ring VI is sleeved on an outer wall of the lower end cover.

10. The waterway system with an RO filter element according to claim 2, wherein the valve assembly comprises an ultrasonic cover, a water cutoff accessory, and a water cutoff piece, wherein a silica gel ring II is sleeved on an outer wall of an upper end of the water cutoff piece, a lower end of the water cutoff piece is located inside the water cutoff accessory, a spring is arranged inside the water cutoff accessory, the spring is sleeved on the lower end of the water cutoff piece, both ends of the spring abut against the water cutoff piece and the water cutoff accessory, respectively, the ultrasonic cover is fixed on the outer cylinder, and a silica gel ring I is arranged between the ultrasonic cover and the water cutoff accessory.
